(19) United States
(12) Patent Application Publication
(10) Pub. No.: US 2007/0177265 A1
(43) Pub. Date: Aug. 2, 2007

(54) Device for the protection of the bodywork of a vehicle

(76) Inventor: Paolo Focardi, Impurneta (FI) (IT)

Correspondence Address: RATNERPRESTIA, P O BOX 980, VALLEY FORGE, PA, 19482-0980, US

(21) Appl. No.: 10/576,624

(22) PCT Filed: Oct. 22, 2004
(86) PCT No.: PCT/EP04/52642

§ 371 Date: Aug. 4, 2006

(30) Foreign Application Priority Data
Oct. 23, 2003 (FI) 2003A00270

(51) Int. Cl. B60R 1/06

(52) U.S. Cl. 359/509

(57) ABSTRACT

A device for protecting the bodywork of a motor vehicle includes a flexible laminar element, able to be laid out to cover the motor vehicle, and a mainly longitudinal developed housing structure, provided with a connection unit means to the motor vehicle, which contains the laminar element when it is in an inoperative conditions. The device includes a cleaning unit coupled with the housing structure. Moreover, it is provided that the flexible laminar element is a support element for advertisements, information, and decorative elements.

This application is a U.S. National Phase Application of PCT International Application PCT/EP2004/052642 and incorporated by reference herein.

### BACKGROUND OF THE INVENTION

The invention is about a device for protecting a motor vehicle bodywork, suitable in particular to be externally applied on said motor vehicle to obtain its covering.

This allows to protect the motor vehicle from harmful weather phenomena, such as violent precipitations and sunrays in the summer period, and harsh and intense cold in winter, which leads to ice formation on the bodywork, the windshield and the rear window.

Even the protection from pollutant agents, like smog, harmful for the motor vehicle bodywork or paint, is achieved.

It is well-known to protect a motor vehicle bodywork from very dangerous weather phenomena, like for example hail or sunrays during the hottest months of the year, or from aggressive pollutant agents, like the smog produced in large industrial areas, the motor vehicle is sheltered in a garage, consisting for instance of a room belonging to a house building or a prefabricated lockup, or under a carport, for example in a workplace parking. However, it often happens that the user is unable to park the motor vehicle sheltered from bad weather, especially if he lives in a town-centre, where covered stalls near his own home are insufficient, or if the company in which he works does not have a covered parking.

Said situation also occurs in those cases in which the user leaves his own car parked in a public parking for a lot of time.

In all the aforementioned situations, the motor vehicle can be protected only having at disposal just an ordinary cloth that, in case of an unexpected violent precipitation, like a hailstorm, is laid on the motor vehicle.

This is obviously a makeshift solution, which furthermore causes a not very pleasant aesthetical impact, and consequently it is not often carried out.

On the other hand, panels with a bellows structure are available, allowing to protect from sunrays, especially in the hot season, at least the motor vehicle dashboard.

However, these panels can be arranged inside the car only, between the inner surface of the windshield and the dashboard, and they leave said car without protection with respect to the aforementioned weather phenomena and pollutant agents.

For the previously mentioned reasons, it is thus evident that the motor vehicle is often at the mercy of even unpredictable weather phenomena and pollutant agents, with all the inconveniences involved.

Document WO 94/25303 shows a device for protecting a motor vehicle bodywork, provided with a container housing a roller therein, around which a cloth used to cover the motor vehicle is wound.

The aforementioned protection device has some limitations.

The first limitation is due to the fact that it is not provided with a practical cloth cleaning system.

This cleaning is essential, because weather phenomena, dust or pollutant agents cause the worsening of the cloth upper surface cleaning condition. Moreover, in the prior art, and in particular in the cited known technique closest to the invention hereby described, it is not evidenced the fact that the cloth, when it covers the motor vehicle bodywork, is usable as a support surface of graphic symbols well visible for the persons, having advertising purposes, of identification or decoration.

### SUMMARY OF THE INVENTION

The present invention intends to overcome the aforementioned inconveniences.

In particular, it is the main object of the invention to provide for a motor vehicle bodywork protection device which allows to clean the cloth, without requiring the user's intervention, during the opening and closing stages of said cloth.

It is a second object of the invention to provide for an easy to manufacture motor vehicle bodywork protection device.

It is another object to provide for a protective device which is rapidly and easily applicable by any motor vehicle user.

It is an object of the invention too to provide for a motor vehicle protective device which is suitable to be used against critical weather phenomena in any season and against different pollutant agents.

Not the least object is that of providing a device which, besides protecting a motor vehicle bodywork, is usable at the same time for advertising purposes, of identification or decoration, without requiring the use of substantially steady means such as self-adhesive stickers, colour spraying, cuttings or the like, used nowadays for associating advertising graphic symbols with the motor vehicle.

Said objects are obtained by a device for protecting a motor vehicle bodywork which, according to the content of the main claim, comprises:
at least a flexible laminar element, able to be laid out to cover said motor vehicle;
at least a mainly longitudinal developed housing structure, able to contain said laminar element when it is in inoperative conditions, provided with: connection means to said motor vehicle;
at least a longitudinal slot for the passage of said laminar element from the interior to the outside of said housing structure, and vice versa; handling means, coupled with said laminar element and available to the user, to extract said laminar element from said housing structure and to dispose it to cover said motor vehicle;
hooking means, coupled with said handling means, able to connect said laid out laminar element to said motor vehicle, which is characterized in that it comprises cleaning means, coupled with said housing structure at said longitudinal slot, able to remove the impurities from said laminar element during its movement.

It is also an object of the present invention that the laminar element be a flexible and winding surface comprising one or more writings, drawings, types, symbols, distinctive signs, logos or the like.

Advantageously, the device of the invention is easy to manufacture and it is practically and easily applicable to the motor vehicle by any user.

More advantageously, the invention allows the vehicle's owner to externally protect his motor vehicle bodywork or paint from any harmful weather phenomenon or pollutant agent.

Still advantageously, the device of the invention is extremely easily portable because, in inoperative conditions, it has reduced encumbrance and weight with respect to the above described prior art.

Moreover, it can be arranged in a very easy way, for instance in the motor vehicle's boot, being always at the user's disposal, who can thus utilize it at any time and in any place, even in case a sudden intense precipitation, such as a hailstorm, arises.

Furthermore, the invention makes available a new means for advertising purposes, of identification or decoration, consisting of a cloth belonging to a housing structure removably coupled with the motor vehicle bodywork.

### BRIEF DESCRIPTION OF THE DRAWINGS

The aforesaid objects and advantages will be better highlighted in the description of preferred embodiments of the invention, given in an explanatory way, with reference to the figures of the annexed drawings, wherein:

FIG. 1 is an axonometric view of a motor vehicle provided with the device of the invention;

FIG. 2 is an axonometric view of an enlarged detail of FIG. 1, with the device of the invention in inoperative conditions;

FIG. 3 is a cross sectional view of the device of FIG. 2;

FIG. 4 is a partial sectional axonometric view of the device of FIG. 2; FIG. 4a is an axonometric view of an enlarged detail of FIG. 4;

FIG. 5 is an axonometric view of the device of FIG. 2, in closing conditions;

FIG. 6 is an axonometric view of a different executive embodiment of the device of FIG. 2;

FIG. 7 is a side view of the device of FIG. 6;

FIG. 8 is an axonometric view of a first executive embodiment of the device of FIG. 2;

FIG. 9 is an axonometric view of a second executive embodiment of the device of FIG. 2;

FIGS. 9 to 13 are axonometric views of different executive embodiments of the device of the invention;

FIG. 14 is a side view of another executive embodiment of the device of the invention; and

FIGS. 15 and 16 are top views of further executive embodiments of the device of the invention.

### DESCRIPTION OF THE INVENTION

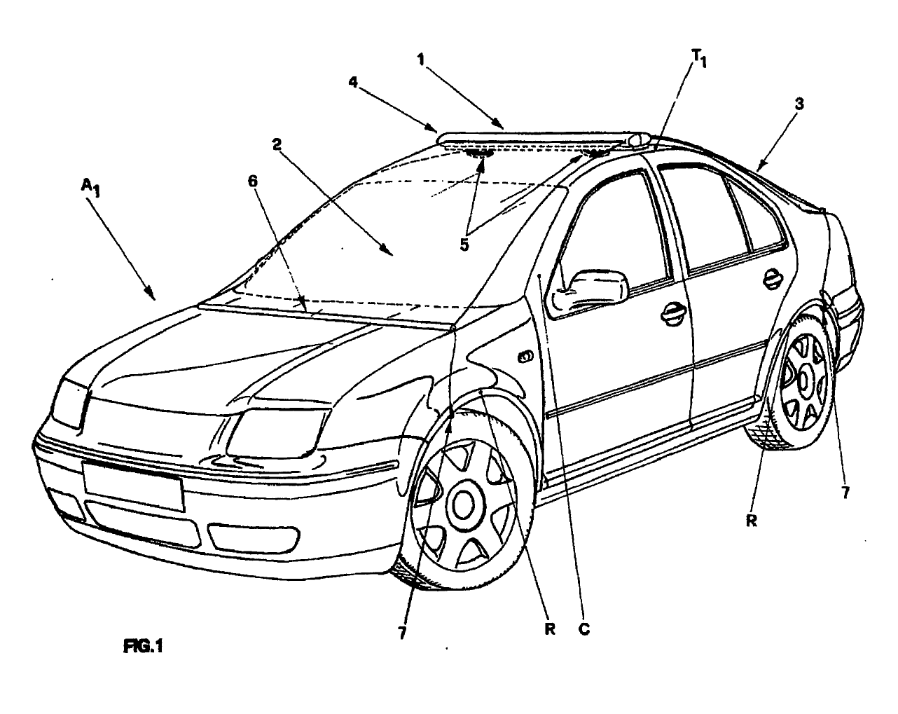

The device of the invention is shown in operative conditions in FIG. 1, where it is generally indicated with numeral 1, disposed to protect the bodywork C of a motor vehicle, generally indicated with A₁.

As one can see, the device 1 comprises two flexible laminar elements, generally indicated with numerals 2 and 3, which are laid out to cover the motor vehicle A₁.

In particular, the laminar element 2 covers the front portion, while the laminar element 3 covers the rear portion of the motor vehicle A₁.

The device 1 comprises a mainly longitudinal developed housing structure, generally indicated with numeral 4, which contains the laminar elements 2, 3 when they are in inoperative conditions.

Said housing structure 4 is provided with:
connection means, generally indicated with numeral 5, to the motor vehicle A₁;
two longitudinal slots, of which only one, indicated with numeral 9, is shown, allowing the passage of the laminar elements 2, 3 from the interior to the outside of the housing structure 4, and vice versa.

It is pointed out that the laminar element 2 passes through the longitudinal slot 9.

The device 1 therefore comprises handling means, generally indicated with numeral 6, coupled with the laminar elements 2, 3 and available to the user, for instance the owner of the motor vehicle A₁.

The handling means 6 are operated to extract the laminar elements 2, 3 from opposite sides of the housing structure 4, and to dispose them to cover the motor vehicle A, in the manner shown in FIG. 1.

As evidenced in the same Figure, the device 1 further comprises hooking means, generally indicated with numeral 7, coupled with the handling means 6, joining the two laminar elements 2, 3 to the motor vehicle A, when they are fully laid out.

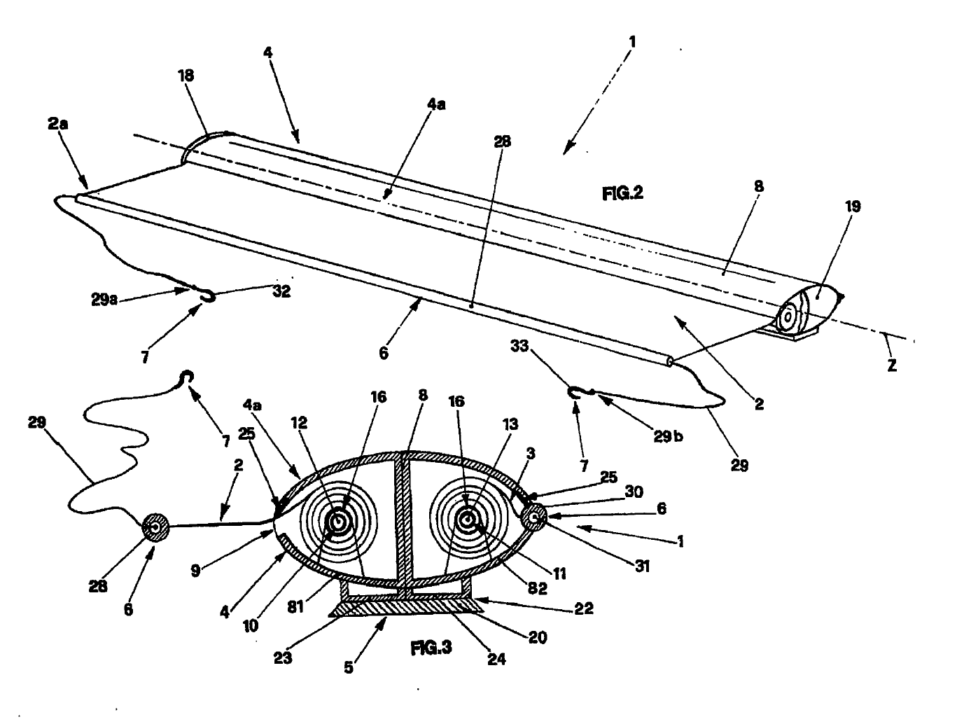

More particularly, the FIG. 2 shows that the handling means 6 consist of a tubular element 28, coupled with the free end 2a of the laminar element 2 and internally provided with an elastic wire 29, to whose ends 29a, 29b the hooking means 7 are applied, consisting in their turn of hooks 32, 33 which, as visible in FIG. 1, are joined to the wheelhouses R when the laminar element 2 has to be positioned to cover the front portion of the motor vehicle A₁.

What previously explained for the laminar element 2 is also applicable for the laminar element 3, which protects the rear portion of the motor vehicle A₁ and whose handling means 6, visible in FIG. 3, consist of the tubular element 30 internally provided with the elastic wire 31, while the hooking means 7, for exposition simplicity, are not shown in the subsequent Figures.

In further executive embodiments, the hooking means could be of different kind, for example magnetic elements to be positioned near the motor vehicle bodywork to maintain stretched the laminar element.

Concerning the housing structure 4, the FIG. 2 shows that it consists of a shell 8 having a cross sectional profile of essentially elliptic shape, to avoid dust or impurities of other kind to deposit on the outer surface 4a of the housing structure 4.

In FIG. 3 said constructive shape of the shell 8 is better highlighted, composed by two half-shells 81, 82 obtained by laminated aluminium extrusion and disposed side by side at the longitudinal symmetry axis Z of the housing structure 4.

According to other constructive embodiments of the invention, the shell could be made of PVC or carbon fibre, just to mention some of the materials preferably usable for this component.

With reference to the laminar elements 2, 3, FIGS. 2 and 3 show that each of them has an end fixed to a support element, generally indicated with numerals 10, 11, disposed inside the housing structure 4, and developed according to the longitudinal symmetry axis Z of the housing structure 4 for a length substantially equal to the length of the longitudinal slot previously indicated with numeral 9.

In this specific case, the support element 10, 11 consists of a winding cylinder 12, 13 around which the respective laminar element 2, 3 is wound or unwound during the release operation from the covering position of the motor vehicle A₁, or the tensioning operation to the closed position.

The laminar elements 2, 3 consist respectively of a roll-up cloth 14, 15, of known type for carrying out covering surfaces to protect vehicles, persons or other from weather phenomena, like for instance high intensity sunrays and beating rain.

Preferably, the roll-up cloth 14, 15 has a thickness of about 1,5 mm and it is made of laminated PVC with a silver coloured polyethylene terephthalate (PET) film.

This allows the roll-up cloth 14, 15 to resist high temperatures to the order of 80° C. during the hottest seasons, since said material has a high deflection coefficient and a low reflection degree of the sunrays.

According to the invention, the device 1 comprises cleaning means, generally indicated with numeral 25, coupled with the housing structure 4 at the longitudinal slot of the type indicated with numeral 9, which perform their function during the movement, that is the opening and closing, of the laminar elements 2, 3, removing the impurities deposited on them when they are laid out on the motor vehicle A₁, as shown in FIGS. 3 and 4 and in the enlargement of FIG. 4 designated as FIG. 4a.

The cleaning means 25 are applied to a support bar 26 connected to the inner surface 4c of the housing structure 4 through joining means, not shown but consisting, for example, of adhesive substances.

Preferably but not necessarily, the cleaning means 25 consist of a strip of woven wires 27, soaked with silicone to minimize light passage, to resist temperature variations and to make waterproof said strip.

In FIGS. 3 and 4 one can see that the device 1 of the invention comprises elastic means, generally indicated with numeral 16, disposed inside the housing structure 4, which maintain in tension the laminar elements 2, 3.

The elastic means 16 are placed at the end 4b of the housing structure 4, but it is evident that, in other constructive embodiments, they could be provided at the opposite end of said structure too.

In FIG. 4 it is shown that the housing structure 4 is provided with a pair of shaped brackets, of which only one, indicated with numeral 17, is visible, each laterally coupled with the housing structure 4 through joining means of known type, not shown hereby, for example screws.

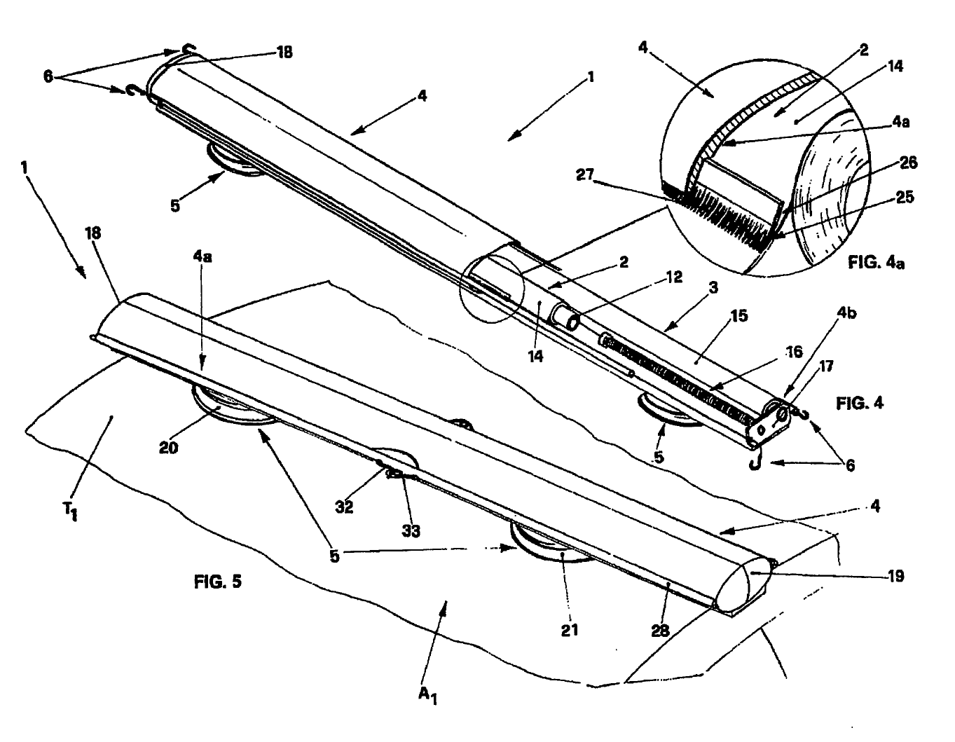

As one can see in the subsequent FIG. 5, but also in FIG. 2, each of the aforementioned shaped brackets is externally provided with a cap 18, 19, made of PVC, which is disposed to laterally cover the housing structure 4 for giving it a homogeneous aesthetical aspect.

According to the preferred executive embodiment hereby described, the connection means 5, shown in section in FIG. 3 and in axonometric view in FIGS. 4 and 5, comprise a pair of magnets 20, 21, coupled with the roof T₁, of the motor vehicle A₁ and joined through first fixing means, generally indicated with numeral 22, to the outer surface 4a of the housing structure 4.

The first fixing means 22 are composed by screws (not shown in the drawings) that couple in a rigid manner the magnets 20, 21 with bearing elements 23, 24 of the housing structure 4, disposed side by side and substantially U shaped, with their lateral ends longer than the central ends brought near to define a concave surface which is adapted to the convexity of the outer surface 4a of the housing structure 4.

In FIG. 6 another executive embodiment of the invention is shown, in which the device, now generally indicated with numeral 100, differs from that described with reference to Figures from 1 to 5 because the connection means, generally indicated with numeral 103, comprise two flexible belts 104, 105, preferably made of rubber, coupled with the housing structure, generally indicated with numeral 102, and joined in a stable but removable way to the upper post M₂ of the respective door P₂ of the motor vehicle A₂.

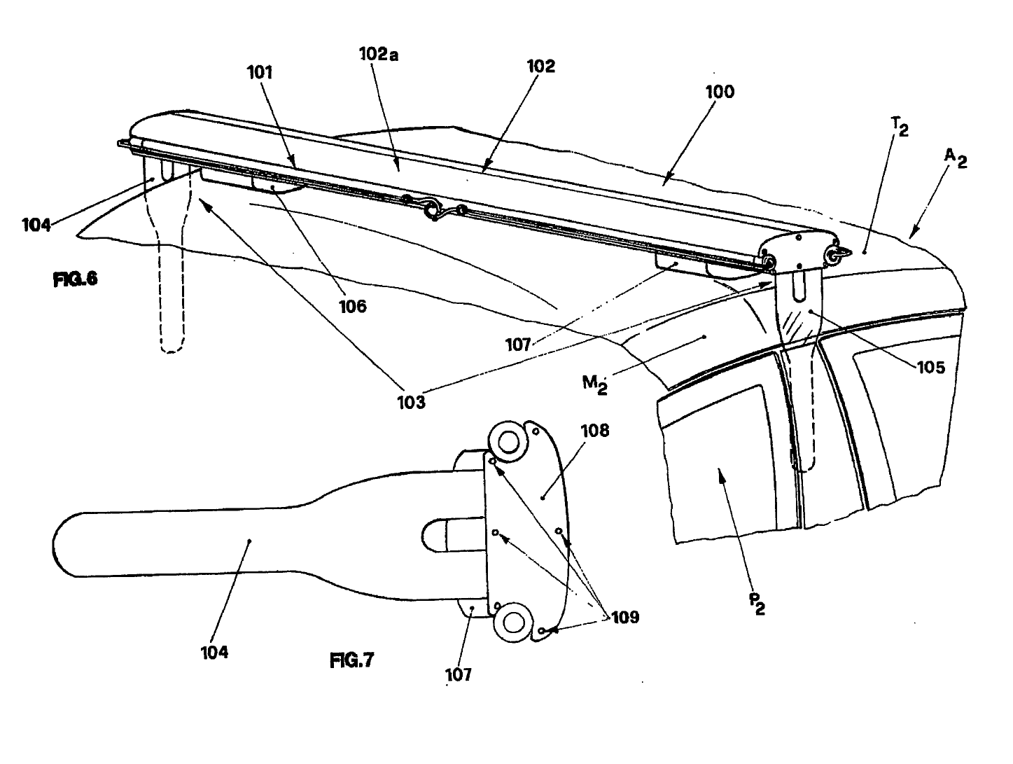

The connection means 103 also comprise a pair of bearing pads 106, 107, preferably made of rubber, coupled with the roof T₂ of the motor vehicle A₂, upon which the outer surface 102a of the housing structure 102 is disposed. FIG. 7 highlights the flexible belt 104 and its connection to the housing structure 102, made stable by the application of the shaped bracket 108 to said housing structure 102 through the joining means 109, consisting for example of screws.

Preferably but not necessarily, the laminar element 101, illustrated in inoperative conditions in FIG. 6, consists of a PTC (acronym of “Positive Temperature Coefficient material”) or aluminium sheet, and it is thus suitable for being used in winter season to protect the motor vehicle A₂ from ice.

In this case, the laminar element 101 is provided with a heating system (not shown in the drawings) of known type, consisting for instance of a metallic frame of small pipes containing antifreeze fluid.

The heating system is coupled with feeding means (not shown in the drawings too) preferably consisting of a rechargeable battery.

The heating fluid could be activated both by pushing a button from the interior of the motor vehicle A₂ and by using a remote control.

FIG. 8 shows a further executive embodiment of the invention, in which the device, generally indicated with numeral 200, still differs from the already described ones for the connection means, generally indicated with numeral 203.

In this case, they comprise a hollow body 204, connected through second fixing means, not shown in the drawings but consisting of screws again, to the outer surface 202a of the housing structure, generally indicated with numeral 202, to define a space 205 in which two shaped bars are inserted from opposite sides, of which only one, indicated with numeral 206, is visible in FIG. 8.

Each shaped bar has an end, indicated with numeral 206a for the shaped bar 206, rigidly fixed to the respective vertical post M₃ of the motor vehicle A₃, carrying out in this way a stable and almost not removable coupling of the device 200, differently from the devices 1 and 100 which are coupled in an easily removable way to the respective motor vehicle A₁, A₂.

At last, in FIG. 9 another executive embodiment of the invention is shown, in which the device, generally indicated with numeral 300, differs from the previously described ones in that each of the laminar elements, generally indicated with numerals 301 and 302 respectively, consists of a pliant cloth 305, 306 respectively, with bellows configuration.

According to the preferred executive embodiment hereby described, the support element, indicated with numeral 304, consists of the inner surface 303c of the housing structure, generally indicated with numeral 303, to which the laminar elements 301, 302 are connected according to known methods.

Operatively, the user applies the device 1 of FIG. 1 on the motor vehicle A₁, by anchoring the magnets 20, 21, previously fixed to the housing structure 4, on the roof T₁.

In inoperative conditions, the device 1 appears as it is shown in FIG. 5, with the hooks 32, 33 mutually coupled at the middle zone of the housing structure 4.

In case of critical weather conditions, like beating sun, the user releases the hooks 32, 33 from their mutual coupling, grasps the tubular element 28 and exerts on it a traction, until the laminar element 2 is disposed to cover the front portion of the bodywork C of the motor vehicle A₁.

Once the laminar element 2 is unwound from the winding cylinder 12 for its entire length, the user fastens it in the reached position, by engaging the hooks 32, 33 with the wheelhouses R of the motor vehicle A₁.

It similarly happens for the laminar element 3, which is disposed to cover the rear part of the motor vehicle A₁, and it is maintained stable thereby by engaging the hooking means with the rear wheelhouses R.

In such situations, the device 1 is able to protect the bodywork C of the motor vehicle Al, granting its outer integrity, from the sunrays action, or even from other harmful weather phenomena, like for instance the hail, very frequent in the summer period too.

When the protection of the motor vehicle A₁, is no more necessary, the user disengages the hooks 32, 33 from the wheelhouses R and, by releasing the grasp on the tubular element 28, he allows the elastic means 16 to draw back the laminar elements 2, 3 inside the housing structure 4.

When he wishes to perform an accurate cleaning of the laminar elements 2, 3, the user holds the tubular element 28 and accompanies their winding movement, opposing the drawback force of the elastic means 16, so that the cleaning means 25 remove the impurities from the cloths 14, 15.

In case of the device 100 of FIG. 6, the user, after leaning the housing structure 102 on the bearing pads 106, 107, couples the belts 104, 105 internally to the upper posts M₂ of the respective door P₂ of the motor vehicle A₂ so that, when the door P₂ is closed, the device 100 is sufficiently fastened to the motor vehicle A₂.

This constructive solution is appropriate when the device 100 has to be applied with great quickness, especially in urgent situations like the unexpected arrival of a summer storm, with the motor vehicle A₂ parked in a public parking.

On the contrary, the embodiment of FIG. 8 is more suitable for those cases in which the device 200 has to be definitely mounted on the motor vehicle A₃, by using fixing means of known type like for instance screws, to fasten the device 200 to the vertical post M₃ of motor vehicle A₃.

The embodiment of FIG. 9 provides for the extraction of the laminar elements 301, 302 from the housing structure 303, to dispose them for covering the motor vehicle A₄ in the same manner with respect to what described for the device 1.

To put the laminar elements 301, 302 back inside the housing structure 303, the user should only folding the respective cloths 306, 307 according to the bellows configuration, not being provided in this case the tensioning elastic means present in all the other embodiments.

Therefore, the device of the invention allows to perform the cleaning of the laminar elements in a practical and automatic way, that is whenever they are extracted or put back from/in the housing structure applied on the motor vehicle bodywork, without an actual intervention of the user.

Consequently, during the subsequent utilizations, the laminar elements belonging to the device of the invention have a better cleaning condition with respect to that granted by equivalent devices of known type, with the evident advantages this involves in aesthetical terms.

The device protects in an effective way the outer part of the motor vehicle bodywork from any weather phenomenon, like hail or sunrays in summer period and ice in winter period, or from the action of pollutant agents, like smog.

The car protection is granted in any period of the year, in any place and with any weather condition.

Due to its reduced encumbrance, the device of the invention can be practically arranged inside the car, for instance in the boot.

This allows the user to have immediately at disposal the device, and to effectively face unpleasant situations, like the unexpected arrival of a hailstorm, even when he is in not sheltered places.

The device of the invention is easily mountable on the motor vehicle, preferably at the middle zone of said vehicle's roof.

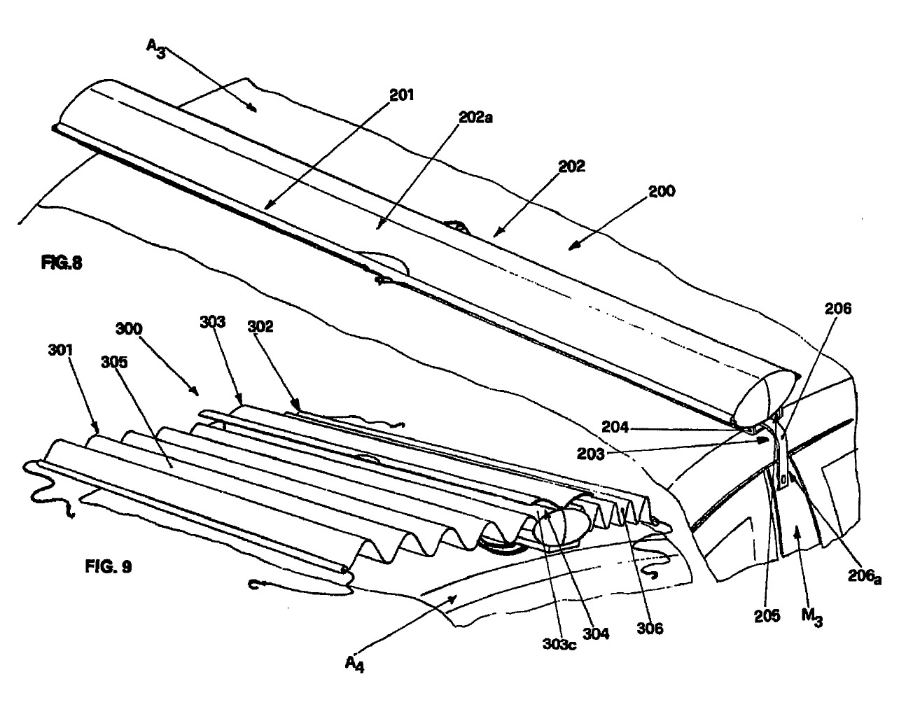

However, according to other executive embodiments of the invention, shown in FIGS. 10 and 11, the housing structure 400 and the connection means could be respectively coupled with the bonnet F or with the boot B of the motor vehicle.

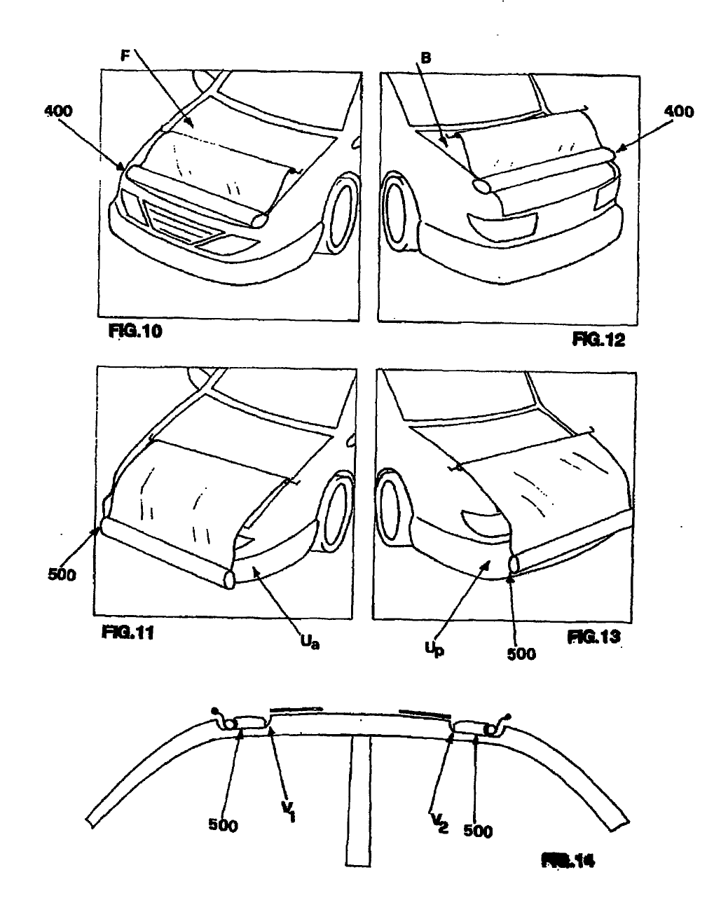

According to other executive embodiments, shown in FIGS. 12 and 13, the housing structure 500 and the related connection means could be coupled with the front bumper Uₐ and/or the rear bumper Uₚ of the motor vehicle.

In such case, the flexible laminar element will be respectively pulled toward the front part or the rear part of the motor vehicle, to be disposed to protect it, and it will obviously have a proper length.

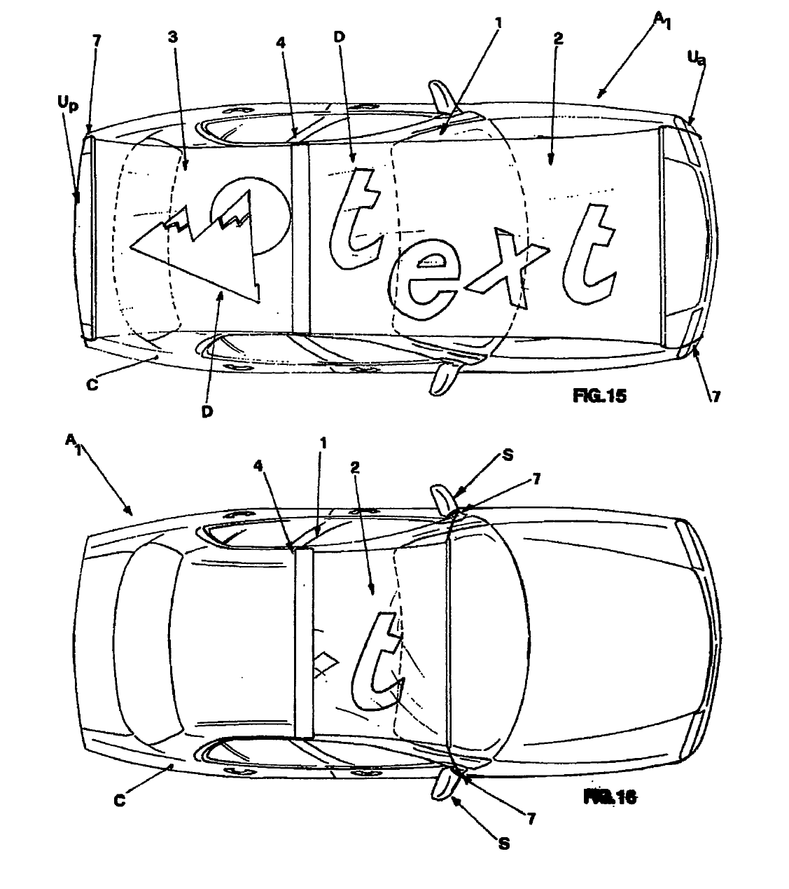

Moreover, in other embodiments, as evidenced in FIG. 14, the housing structure 500 could be housed in one or more spaces V₁, V₂ obtained on the motor vehicle roof.

It is still evident that, in further executive embodiments of the invention, shown in FIGS. 15 and 16, the hooking means 7 could be joined to the front bumper Uₐ and/or the rear bumper Uₚ, or to the wing mirrors S of the motor vehicle, according to the protection degree to grant to said motor vehicle.

Such Figures still show another peculiarity of the invention hereby described which concerns, as previously mentioned, even a flexible and winding surface comprising writings, drawings, types, symbols, distinctive signs, logos and the like, indicated with D, used for advertising purposes.

The flexible surface consists of the flexible laminar elements 2, 3 placed inside the housing structure 4 coupled with the bodywork C of the motor vehicle A₁, laid out to cover said bodywork C.

Obviously, on the outer surface of the flexible laminar elements, but also of the housing structure, any types, drawings, writings, distinctive signs or logos, both with advertising and identification purpose, could be printed, like for example the number plate of the own car, or with decorative purpose, with drawings photographs or special colours.

It is immediately evident the advantage produced by the use of at least one of the cloth of the device of the invention, for instance as advertising surface.

In fact, in this case, a payment to the user of the device by the company owner of the advertisements could be provided.

Otherwise, the device could be freely provided by the supplier of the advertisements.

On the basis of the aforesaid description, it should be understood that the device for protecting a motor vehicle bodywork according to the invention achieves all the objects and attains all the previously mentioned advantages.

Modifications to the device of the invention could be introduced in the productive stage, by providing for instance for a single cloth, coupled with the housing structure, to cover the motor vehicle, as one can see in Figures from 10 to 14.

In other executive embodiments, the device of the invention could comprise a different number of housing structures, for instance two.

Moreover, both the flexible laminar element and the housing structure could be made of any colour, allowing the producer to differentiate and change at his will the aesthetical aspects.

For example, the colour of the device could be combined with the colour of the motor vehicle bodywork, to give a pleasant general aesthetical impact.

The device of the invention could be manufactured in several sizes, to allow its application on different motor vehicle models.

Furthermore, in other constructive embodiments, the housing structure shape could be different from the previously described one, without reducing the advantage provided by the present patent.

All the described and cited embodiments, even if not shown in the annexed drawings, when they should fall within the scope of protection of the following claims, should be considered protected by the present patent.

1. A device for protecting the bodywork of a motor vehicles, comprising:
a flexible laminar element to be laid out to cover at least a portion of said motor vehicle;
substantially longitudinally extending housing structure to contain said laminar element when it is in an inoperative condition in said housing structure, provided with:
connection means to said motor vehicle; and
a longitudinal slot for the passage of said laminar element from the interior to the outside of said housing structure, and vice versa;
handling means coupled with said laminar element and available to a user, to extract said laminar element from said housing structure and to dispose it to cover at least a portion of said motor vehicle;
hooking means coupled with said handling means to connect said laid out laminar element to said motor vehicle, and
cleaning means coupled with said housing structure at said longitudinal slot to clean said laminar element during its movement.

2. The device according to claim 1, wherein said cleaning means are applied to a support bar connected to an inner surface of said housing structure through joining means.

3. The device according to claim 1, wherein said cleaning means includes a strip of woven wires soaked with silicone to minimize light passage, to resist temperature variations and to make it waterproof.

4. The device according to claim 1, wherein said housing structure includes a shell having a cross sectional profile of essentially elliptic shape, to avoid dust or impurities from depositing on the outer surface of said housing structure.

5. The device according to claim 4, wherein said shell is composed of two half-shells disposed side by side at the longitudinal symmetry axis of said housing structure.

6. The device according to claim 5, wherein said laminar element has an end fixed to a support element, disposed in said housing structure , which extends along the longitudinal symmetry axis of said housing structure for a length substantially equal to the length of said longitudinal slot.

7. The device according to claim 6, wherein said support element includes a winding cylinder around which said laminar element is wound/unwound.

8. The device according to claim 6, wherein said support element includes the inner surface of said housing structure.

9. The device according to claim 7, wherein said laminar element includes a roll-up cloth.

10. The device according to claim 8, wherein said laminar element includes a pliant cloth having a bellows configuration.

11. The device according to claim 7, further comprising elastic means disposed in said housing structure to maintain in tension said laminar element.

12. The device according to claim 11, wherein said elastic means are placed at least at an end of said housing structure.

13. The device according to claim 1, wherein said housing structure is provided with a pair of shaped brackets, each of said shaped brackets being laterally coupled with said housing structure through joining means.

14. The device according to claim 13, wherein said shaped brackets is externally provided with a cap.

15. The device according to claim 4, wherein said connection means comprise at least a magnet coupled with a roof or with a front bumper and/or a rear bumper of said motor vehicle and joined through first fixing means to said outer surface of said housing structure.

16. The device according to claim 4, wherein said connection means comprise at least a flexible belt coupled with said housing structure and joined in a stable but removable way to an upper post of a door, to a hood or to a trunk of said motor vehicle, and at least a bearing pad coupled with a roof, with the hood or with the trunk of said motor vehicle, upon which said outer surface of said housing structure is disposed.

17. The device according to claim 4, wherein said connection means comprise at least a hollow body, connected through second fixing means to said outer surface of said housing structure to define at least a space in which at least a shaped bar, provided with at least an end rigidly fixed to the vertical post of said motor vehicle, is inserted.

18. The device according to claim 1, wherein said handling means includes a tubular element applied to a free end of said laminar element and internally provided with an elastic wire to whose ends said hooking means are applied.

19. The device according to claim 1, wherein said hooking means includes hooks to be joined with said bodywork of said motor vehicle.

20. The device according to claim 1, wherein said hooking means includes magnetic elements to be positioned on said bodywork of said motor vehicle.

21. The device according to claim 1, further comprising a heating system of said laminar element, coupled with feeding means and able to prevent ice formation on said laminar element.

22. The device according to claim 1, wherein said flexible laminar element is made of insulating material, able to resist low temperatures during the cold season.

23. The device according to claim 1, wherein said flexible laminar element is made of a material able to resist high temperatures during the hot season.

24. A device for protecting the bodywork of a motor vehicle, comprising:
a flexible laminar element to be laid out to cover at least a portion of said motor vehicle;
a substantially longitudinally extending housing structure to contain said laminar element when it is in an inoperative condition in said housing structure, provided with:
connection means to said motor vehicles; and
a longitudinal slot for the passage of said laminar element from the interior to the outside of said housing structure, and vice versa;
handling means coupled with said laminar element and available to a user, to extract said laminar element from said housing structure and to dispose it to cover at least a portion of said motor vehicle;
hooking means coupled with said handling means to connect said laid out laminar element to said motor vehicle, and
said laminar element being advertising support.
